(19) United States
(12) Patent Application Publication
(10) Pub. No.: US 2014/0193184 A1
(43) Pub. Date: Jul. 10, 2014

(54) DECOLORIZATION PROCESSING METHOD AND DECOLORIZING DEVICE

(71) Applicants: Toshiba Tec Kabushiki Kaisha, Tokyo (JP); Kabushiki Kaisha Toshiba, Tokyo (JP)

(72) Inventor: MAMORU ISHIKAWA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 14/145,651

(22) Filed: Dec. 31, 2013

(30) Foreign Application Priority Data
Jan. 7, 2013 (JP) 2013-000527

(51) Int. Cl. G03G 15/20

(52) U.S. Cl. CPC G03G 21/00
USPC 399/341

(57) ABSTRACT

A decolorization method according to an embodiment includes reading an image that is printed on a sheet surface with a decolorable toner which is decolorized when heated to a decolorizing temperature. The method further includes determining a non-print area of the sheet surface that has no decolorable toner based on the read image and setting the non-print area as a first print target area. The method further includes transferring decolorable toner to the first print target area, and heating the sheet surface having decolorable toner transferred to the first print target area, at the decolorizing temperature by a heating unit.

### CROSS-REFERENCE TO RELATED APPLICATION

This application is based upon and claims the benefit of priority from Japanese Patent Application No. 2013-000527, filed Jan. 7, 2013, the entire contents of which are incorporated herein by reference.

### FIELD

Embodiments described herein relate generally to a technology for decolorizing an image which is formed with a decolorable toner.

### BACKGROUND

In recent years, an image forming device which heats a sheet on which an image is formed with a decolorable toner (i.e., a toner which is decolorized when a temperature thereof reaches a decolorizing temperature) to a decolorizing temperature, and decolorizes the image which is printed on the sheet, has been researched in view of the demand for saving resources. Before the decolorization process (heating process) is performed, the image forming device may transfer the decolorable toner to an entire print surface for security reasons so as to cover the image which has been previously printed, and prevent decrease in visibility when an insufficiently decolorized image remains on the sheet acquired after the decolorization process is performed.

However, in such an image forming device, since an area to which two-layered decolorable toner is fixed and an area to which a single-layered decolorable toner is fixed are generated in the sheet acquired after the decolorization process is performed, it is possible to read the content of the image, which is printed on the sheet acquired before the decolorization process is performed, after the decolorization process is performed due to the difference in the thickness of the fixed areas. Thus, there is a problem of security with respect to the sheet that is a decolorization process target.

### DESCRIPTION OF THE DRAWINGS

FIG. 1 is a view illustrating a schematic configuration of a decolorizing device according to a first embodiment.

FIG. 2 is a block diagram illustrating a hardware configuration of the decolorizing device of FIG. 1.

FIG. 3 is a control flowchart illustrating a decolorization process according to the first embodiment.

FIG. 4(A) is a view illustrating image data which is read by an image reading unit in the decolorizing device of FIG. 1.

FIG. 4(B) is a view illustrating the image data in which a non-print area of FIG. 4(A) is used as a first print target area.

FIG. 4(C) is a view illustrating a sheet acquired after a decolorable toner is transferred to the first print target area.

FIG. 4(D) is a view illustrating a sheet acquired after the decolorization process is performed on the sheet of (C) of FIG. 4.

FIG. 5 is a view illustrating a schematic configuration of a decolorizing device according to a second embodiment.

FIG. 6 is a control flowchart illustrating a decolorization process according to the second embodiment.

FIG. 7(A) is a view illustrating image data which is read by an image reading unit in the decolorizing device of FIG. 5.

FIG. 7(B) is a view illustrating image data in which a non-print area of FIG. 7(A) is used as a first print target area.

FIG. 7(C) is a view illustrating a sheet acquired after a decolorable toner is transferred to the first print target area.

FIG. 7(D) is a view illustrating a sheet acquired after a decolorization process is performed on the sheet of FIG. 7(C).

FIG. 7(E) is a view illustrating a sheet acquired after the decolorable toner is transferred to the entire print surface of the sheet of FIG. 7(D).

FIG. 7(F) is a view illustrating a sheet acquired after the decolorization process is performed on the sheet of FIG. 7(E).

FIG. 8 is a view illustrating a schematic configuration of a decolorizing device according to a third embodiment.

FIG. 9 is a control flowchart illustrating a decolorization process according to the third embodiment.

FIG. 10(A) is a view illustrating image data which is read by an image reading unit in the decolorizing device of FIG. 8.

FIG. 10(B) is a view illustrating image data in which a non-print area of FIG. 10(A) is used as a first print target area,

FIG. 10(C) is a view illustrating a sheet acquired after a decolorable toner is fixed to the first print target area.

FIG. 10(D) is a view illustrating image data in which the non-print area of FIG. 10(C) is used as a third print target area.

FIG. 10(E) is a view illustrating a sheet acquired after the decolorable toner is transferred to the third print target area shown in FIG. 10(D) in the sheet of FIG. 10(C).

FIG. 10(F) is a view illustrating a sheet acquired after the decolorization process is performed on the sheet of FIG. 10(E).

### DETAILED DESCRIPTION

A decolorization method according to an embodiment includes reading an image that is printed on a sheet surface with a decolorable toner which is decolorized when heated to a decolorizing temperature. The method further includes determining a non-print area of the sheet surface that has no decolorable toner based on the read image and setting the non-print area as a first print target area. The method further includes transferring decolorable toner to the first print target area, and heating the sheet surface having decolorable toner transferred to the set first print target area, at the decolorizing temperature by a heating unit.

### First Embodiment

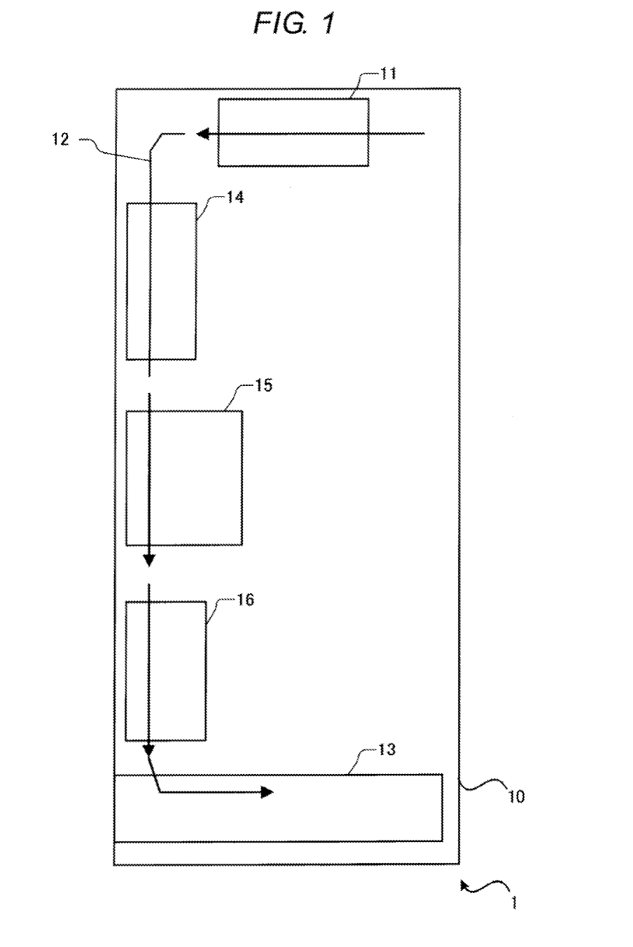

Hereinafter, a decolorizing device 1 according to a first embodiment will be described with reference to the accompanying drawings. FIG. 1 is a schematic diagram illustrating the decolorizing device 1 according to the first embodiment.

The decolorizing device 1 heats a sheet, on which an image is formed with a toner (hereinafter, referred to as a decolorable toner) that is decolorized when a temperature thereof reaches a decolorizing temperature (in the embodiment, a temperature in the range of approximately 190° C. to 220° C.). At the decolorizing temperature, the decolorable toner which is in a color developed state is caused to be in a decolorized state, and the image on the sheet is decolorized. Alternatively, the decolorizing device 1 may radiate light, such as near infrared rays, onto the sheet as a decolorization process, and may decolorize the image on the sheet. In this case, it is assumed that the image on the sheet is formed with a decolorable toner which is decolorized by radiating light, such as near infrared rays. It is possible to use a decolorable toner which is decolorized using, for example, light in the vicinity of a wavelength of 820 nm and which does not react to light in the vicinity of a wavelength of 600 nm that is radiated from a fluorescent light.

As shown in FIG. 1, the decolorizing device 1 delivers sheets that are received in a paper feeding unit 11, which is positioned on the upper side of a decolorizing device main body 10, to a transportation path 12 one by one. The sheet is discharged to a reuse paper tray 13, which is positioned on the lower side of the decolorizing device main body 10.

An image reading unit 14, an image forming unit 15 and a heating and decolorizing unit (heating unit) 16 are placed in the middle of the transportation path 12.

The image reading unit 14 is, for example, a scanner, and reads an image which is printed by the decolorable toner on the sheet that is delivered from the paper feeding unit 11 to the transportation path 12, and stores the read image data in a storage unit 20 which will be described later.

As shown in FIG. 1, the image forming unit 15 is positioned on the downstream side of the image reading unit 14 in the sheet transportation direction, and transfers the decolorable toner to an entire print target area (which includes a first print target area, a second print target area, and a third print target area) which is set by a control unit 21 which will be described later.

The image forming unit 15 includes a photoreceptor provided with a photosensitive layer on the surface thereof, (not shown) which rotates in a counterclockwise fashion. The image forming unit also includes, in the vicinity of the photoreceptor, a charging unit (not shown) that uniformly charges the surface of the photoreceptor, and an exposing unit (not shown) that exposes the photosensitive layer which is uniformly charged by the charging unit and that forms an electrostatic latent image. The image forming unit also includes a developing unit (not shown) that develops the electrostatic latent image, which is formed through exposure performed by the exposing unit, by a toner. The image forming unit also includes a transfer unit (not shown) that transfers the toner image which is developed by the developing unit to the sheet, and a cleaning unit (not shown) that recovers the toner which is charged to the sheet by the transfer unit.

As shown in FIG. 1, the heating and decolorizing unit 16 is positioned on the downstream side of the image forming unit in the sheet transportation direction. The heating and decolorizing unit 16 is, for example, a heating roller. The heating and decolorizing unit 16 heats and fixes a toner image which is transferred to the sheet, and decolorizes the toner image which is transferred to the sheet. More specifically, if decolorization process setting is input in an operation input unit 22 which will be described later, the heating temperature of the heating and decolorizing unit 16 is set to a decolorizing temperature (in the embodiment, a temperature in the range of approximately 190° C. to 220° C.). The sheet which is transported to the heating and decolorizing unit 16 is heated and pressed. Since heating at the decolorizing temperature is performed at a temperature which is higher than a fixing temperature (in the embodiment, in the range of approximately 150° C. to 160° C.), the toner image which is transferred to the sheet during fixing is thermally welded, and thus an image is fixed to the sheet. In addition, when the image which is fixed to the sheet is heated at the decolorizing temperature, the state thereof changes from a color developed state to a decolorized state, and thus the image on the sheet is decolorized.

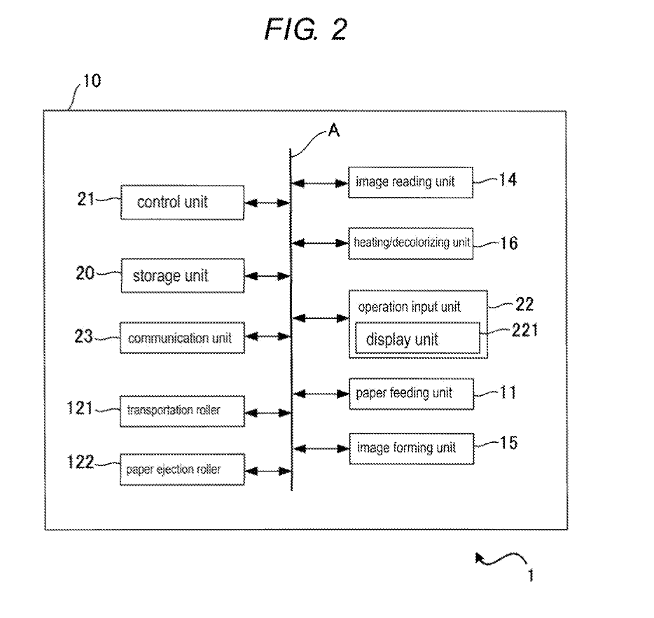

FIG. 2 is a block diagram illustrating a hardware configuration of the decolorizing device 1.

As shown in FIG. 2, the decolorizing device 1 includes the operation input unit 22, a display unit 221, the storage unit 20, the control unit 21, the image reading unit 14, the heating and decolorizing unit 16, a communication unit 23, a paper feeding unit 11, the image forming unit 15, a transportation roller 121, a the paper ejection roller 122. Each of the elements is connected through a bus A.

The operation input unit 22 includes the touch panel-type display unit 221 and operation keys (not shown), such as numerical keys, a stop key, and a start key, and receives operation inputs, such as a decolorization process setting or a security setting, from a user. The decolorization process setting is input when a decolorization process is to be performed on an image which is printed on a sheet received in the paper feeding unit 11 of the decolorizing device 1. The security setting is input when a decolorization process is to be performed on an image, which is printed on a sheet acquired before the decolorization process is performed, in the form in which reading is not possible from a sheet acquired after the decolorization process is performed.

The display unit 221 displays setting information, such as the decolorization process setting or the security setting, the operation status of the decolorizing device 1, log information, and notifications provided to the user.

The storage unit 20 is a memory which is configured with, for example, a volatile or non-volatile storage device, and stores image data which is read by the image reading unit 14 and various information or programs which are used in the decolorizing device 1. In particular, the storage unit 20 stores information or a program, which is necessary to be stored, in a non-volatile area. The storage unit 20 is configured with, for example, a Random Access Memory (RAM), a Read Only Memory (ROM), a Dynamic Random Access Memory (DRAM), a Static Random Access Memory (SRAM), a Video RAM (VRAM) and/or a Hard Disk drive (HDD).

The control unit 21 is a processor such as, for example, a Central Processing Unit (CPU), and controls the entire decolorizing device 1. The control unit 21 performs various processes of the decolorizing device 1, and executes programs which are related to various functions stored in the storage unit 20.

When the decolorization process setting or the security setting is input in the operation input unit 22, the control unit 21 analyzes image data which is read by the image reading unit 14, determines the non-print area, i.e., an area in which the decolorable toner is not printed, of the image data, and sets the non-print area as a first print target area. Further, the control unit 21 operates the image forming unit 15 and the heating and decolorizing unit, transfers the decolorable toner to the first print target area, and heats the sheet, to which the decolorable toner is transferred, at a decolorizing temperature, thereby performing the decolorization process on the image of the sheet. The decolorization process will be described in detail later.

Meanwhile, functions which are implemented using the storage unit 20 and the control unit 21 may be implemented by mounting an Application Specific integrated Circuit (ASIC).

The communication unit 23 connects to a wireless or wired network, and connects one or more information terminals (for example, personal computers, not shown) or a server (not shown) to the decolorizing device 1 via the network. The communication unit 23 transmits various information stored in the server or the decolorization process setting or the security setting selected by the user in the information terminal to the decolorizing device 1.

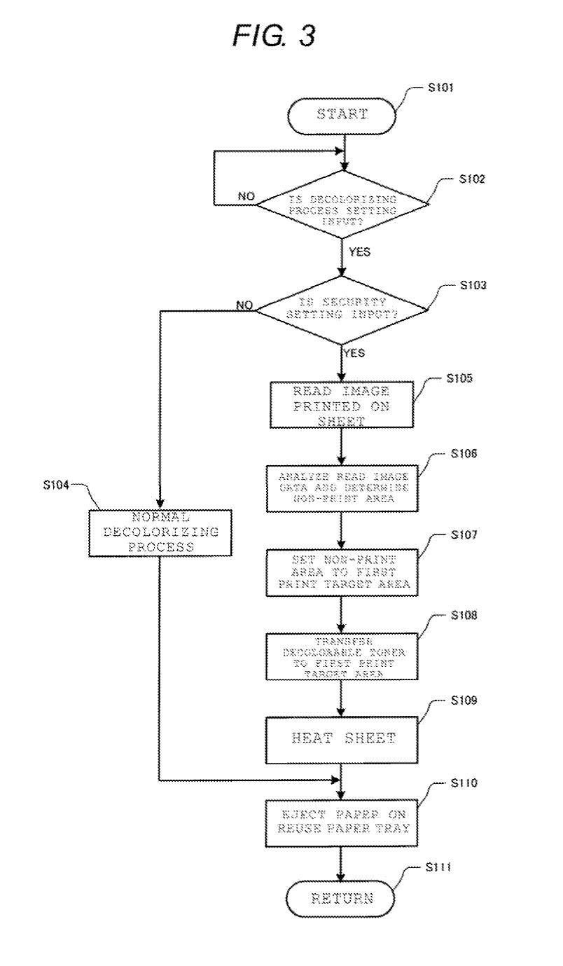

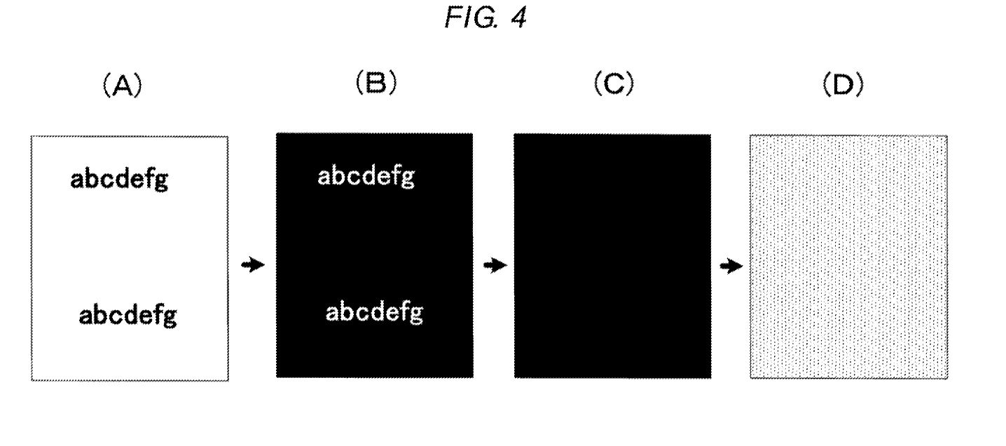

A processing operation related to the decolorizing device 1 according to the first embodiment is now described in connection with FIGS. 3 and 4(A)-4(D).

With reference to FIG. 3, if the control unit 21 determines that the decolorization process setting is input in the operation input unit 22 by the user, the control unit 21 determines whether or not a security mode is input in the operation input unit 22 by the user in steps S101, S102 (YES), and S103.

When the control unit 21 determines that the security setting is not input in the operation input unit 22, the control unit 21 performs a normal decolorization process on the image (an image which is formed with the decolorable toner) of the sheet which is transported from the paper feeding unit 11 to the transportation path 12 in steps S103 (NO) and S104.

Here, the normal decolorization process is performed in such a way that the control unit 21 operates the paper feeding unit 11, the transportation roller 121, the heating and decolorizing unit 16, and the paper ejection roller 122, and heats the sheet, which is transported from the paper feeding unit 11 to the transportation path 12, at the decolorizing temperature by the heating and decolorizing unit 16, thereby performing the decolorization process on the image of the sheet.

When the control unit 21 determines that the security setting is input in the operation input unit 22, the control unit 21 operates the paper feeding unit 11 and the image reading unit 14, transports the sheet which is received in the paper feeding unit 11 to the image reading unit 14, reads an image which is printed on the sheet, and stores image data as shown in FIG. 4(A) in the storage unit 20 in steps S103 (YES) and S105. The control unit 21 analyzes the image data which is stored in the storage unit 20, and determines a non-print area in which the decolorable toner is not printed in step S106. The control unit 21 sets the first print target area as shown in FIG. 4(B) by using the non-print area as an area, to which the decolorable toner is transferred, in step S107. The control unit 21 operates the image forming unit 15, transfers the decolorable toner to the entire first print target area, and causes the entire print surface of the sheet as shown in FIG. 4(C) to be formed in a state in which a single-layered decolorable toner is transferred in step S108. Further, the control unit 21 operates the heating and decolorizing unit 16, sets the heating temperature of the heating and decolorizing unit 16 to the decolorizing temperature, and heats the sheet, to which the image is transferred by the decolorable toner, at the decolorizing temperature, thereby decolorizing the image of the sheet as shown in FIG. 4(D in step S109.

The control unit 21 operates the paper ejection roller 122, discharges the sheet on which the decolorization process is performed to the reuse paper tray 13, and ends the process in steps S110 and S111.

Since the decolorizing device 1 according to the first embodiment transfers the decolorable toner to an area (non-print area) other than the area on which the decolorable toner is printed in advance, it is possible to form the entire surface, on which the decolorization process is performed, of the sheet as shown in (D) of FIG. 4 using a surface to which a single-layered decolorable toner is uniformly fixed. Therefore, a sheet on which a decolorization process is performed by the decolorizing device 1 according to the first embodiment is different from a sheet on which a decolorization process is performed by an image forming device according to the related art. Since a difference between an area on which the decolorable toner is printed and an area on which the decolorable toner is not printed (or a difference between an area to which a single-layered decolorable toner is fixed and an area to which a two-layered decolorable toner is fixed) is not generated, it is possible to prevent an image that was printed on a sheet acquired before a decolorization process is performed, from being read. That is, with regard to the sheet acquired after the decolorization process is performed, the decolorizing device 1 according to the first embodiment performs the decolorization process in a state in which an image which is printed on the sheet acquired before the decolorization process is performed cannot be read. Thus it is possible to increase a security level related to a sheet which is a target of the decolorization process.

### Second Embodiment

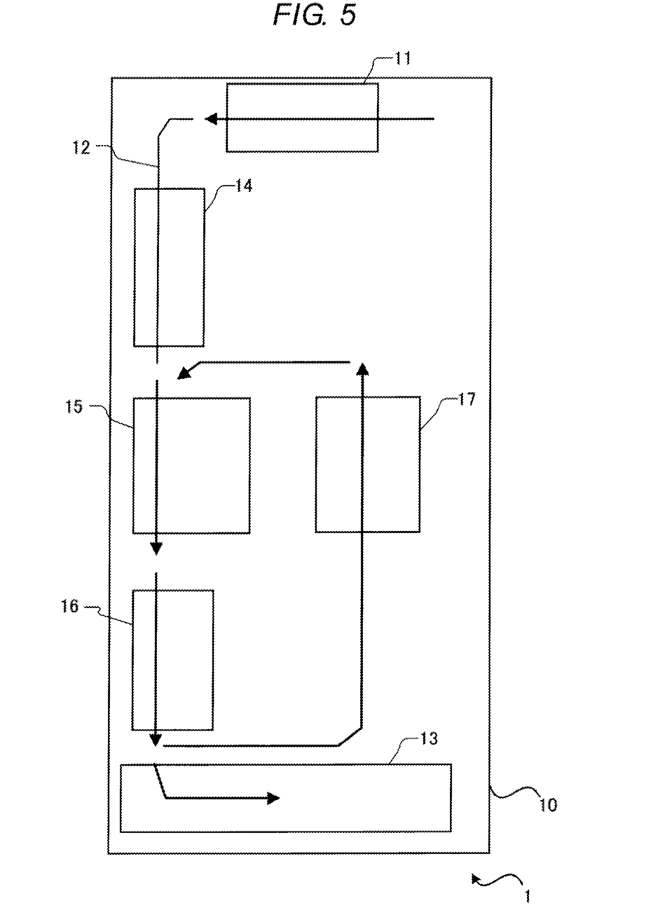

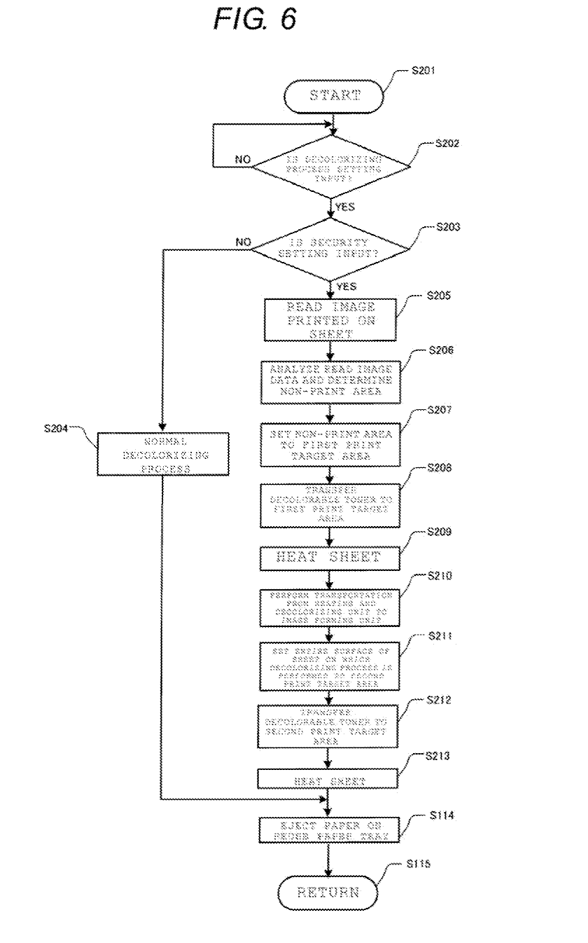

A second embodiment is now described in connection with FIGS. 5, 6, and 7(A)-7(F).

As shown in FIG. 5, the decolorizing device 1 according to the second embodiment is configured to further include a first reverse transportation unit 17, which branches from the heating and decolorizing unit 16 on the downstream side of the heating and decolorizing unit 16 in the sheet transportation direction, and which transports the sheet on which the decolorization process is performed by the heating and decolorizing unit 16 to the image forming unit 15, in addition to the decolorizing device according to the first embodiment. Since the other configurations are the same as those of the decolorizing device 1 according to the first embodiment, the description thereof will not be repeated.

A processing operation related to the decolorizing device 1 according to the second embodiment will be described.

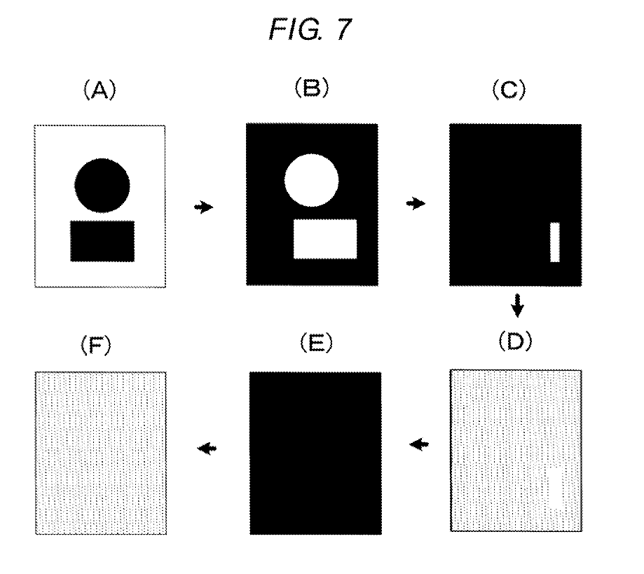

The control unit 21 determines that the decolorization process setting and the security setting are input in the operation input unit 22 insteps S201, S202 (YES), and S203 (YES). Thereafter, similar to the processing operation according to the first embodiment, the control unit 21 heats a sheet (shown in FIG. 7(C), in which the decolorable toner is fixed to the first print target area, by the heating and decolorizing unit 16, up to the decolorization process temperature, and decolorizes an image printed on the sheet as shown in FIG. 7(D) in steps S205 to S209. Meanwhile, since the decolorization process operations according to the second embodiment in steps S201 to S209 are the same as the decolorization process operation according to the first embodiment in steps S101 to S109, the description thereof will not be repeated.

The control unit 21 operates the first reverse transportation unit 17, and transports a sheet, on which the decolorization process is performed by the heating and decolorizing unit 16, to the image forming unit 15 in step S210. The control unit 21 sets a second print target area in which the decolorable toner is printed with regard to the entire surface, on which the decolorization process is performed, of the sheet, operates the image forming unit 15, and transfers the decolorable toner to the entire second print target area as shown in FIG. 7(E) in steps S211 and S212. The control unit 21 operates the transportation roller 121 and the heating and decolorizing unit 16, sets the heating temperature of the heating and decolorizing unit 16 to the decolorizing temperature, transports the sheet, in which the decolorable toner is transferred to the second print target area, to the heating and decolorizing unit 16, heats the sheet at the decolorizing temperature by the heating and decolorizing unit 16, and decolorizes an image which is transferred to the sheet as shown in FIG. 7(F) in step S213. In addition, the control unit 21 operates the paper ejection roller 122, discharges the sheet, on which the decolorization process is performed by the heating and decolorizing unit 16, to the reuse paper tray 13, and ends the process in steps S114 and S115.

In the decolorizing device 1 according to the second embodiment, even when the control unit 21 transfers the decolorable toner to the sheet while the first print target area which is set by the control unit 21 is deviated from the non-print area of the sheet acquired before the decolorization process is performed (even when the decolorable toner is transferred to the sheet as shown in FIG. 7(D)), the operation of transferring the decolorable toner to the entire surface, on which the decolorization process is performed, of the sheet is performed after the operation of transferring the decolorable toner is performed on the first print target area. Thus it is possible to prevent an area to which the decolorable toner is not transferred from being generated in the surface, on which the decolorization process is performed, of the sheet.

That is, in the decolorizing device 1 according to the second embodiment, since the decolorable toner is fixed to the entire surface of the sheet after the decolorization process is first performed, it is possible to prevent an image, which is printed on the sheet acquired before the decolorization process is performed, from being read without generating a difference in the quantity of fixing the decolorable toner (for example, difference between an area to which the decolorable toner is fixed and an area to which the decolorable toner is not fixed) after the decolorization process is performed. With such a configuration, it is possible for the decolorizing device 1 according to the second embodiment to increase a security level related to the sheet which is the decolorization process target, compared to the decolorizing device 1 according to the first embodiment.

### Third Embodiment

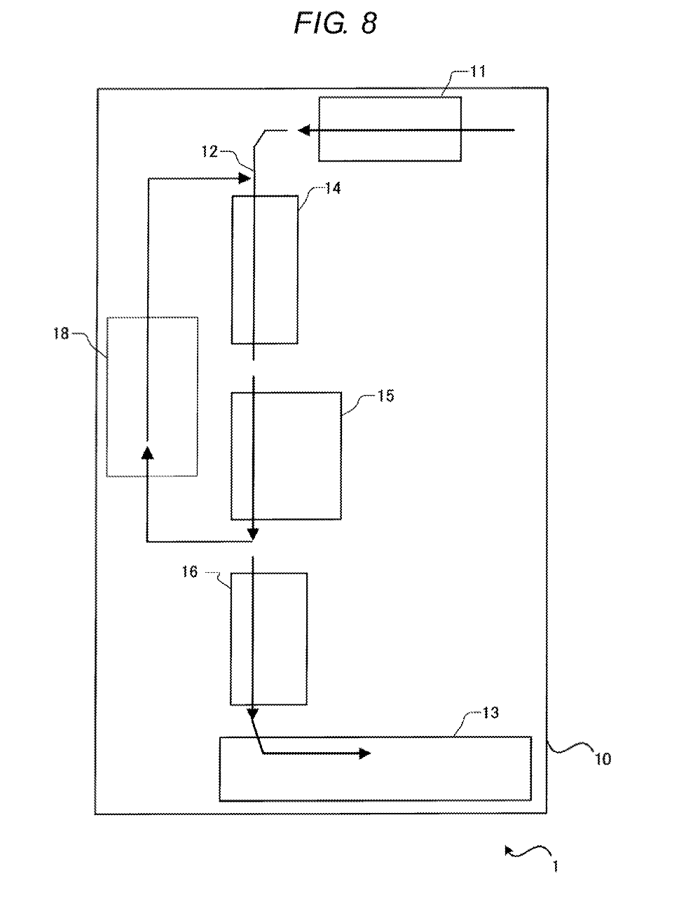

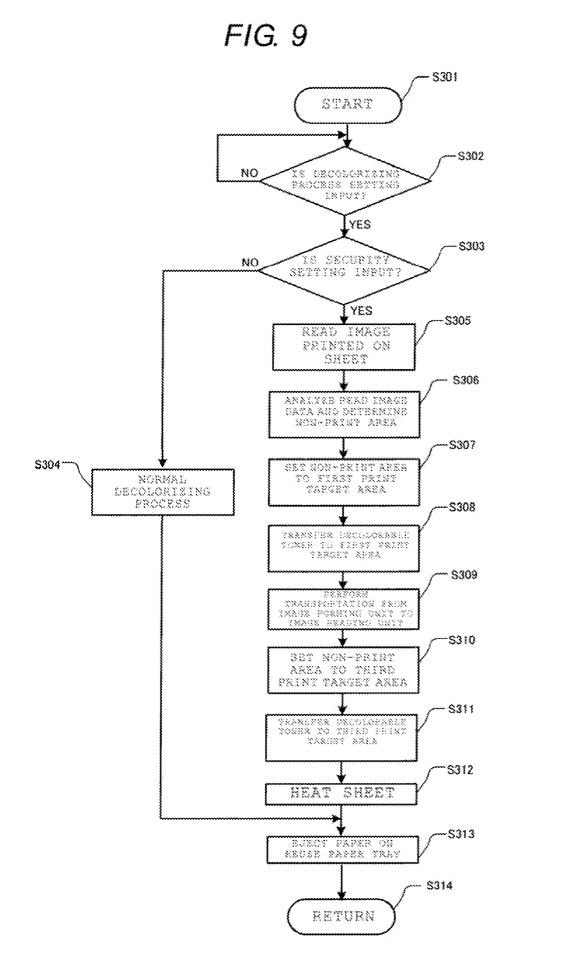

A third embodiment is now described in connection with FIGS. 8, 9 and 10(A)-10(F).

As shown in FIG. 8, the decolorizing device 1 according to the third embodiment is configured to further include a second reverse transportation unit 18, which branches from the image forming unit 15 on the downstream side of the image forming unit 15 in the sheet transportation direction, and which transports the sheet to which the decolorable toner is transferred in the image forming unit 15 to the image reading unit 14, in addition to the decolorizing device 1 according to the first embodiment. Since the other configurations are the same as those of the decolorizing device 1 according to the first embodiment, the description thereof will not be repeated.

A processing operation related to the decolorizing device 1 according to the third embodiment will be described.

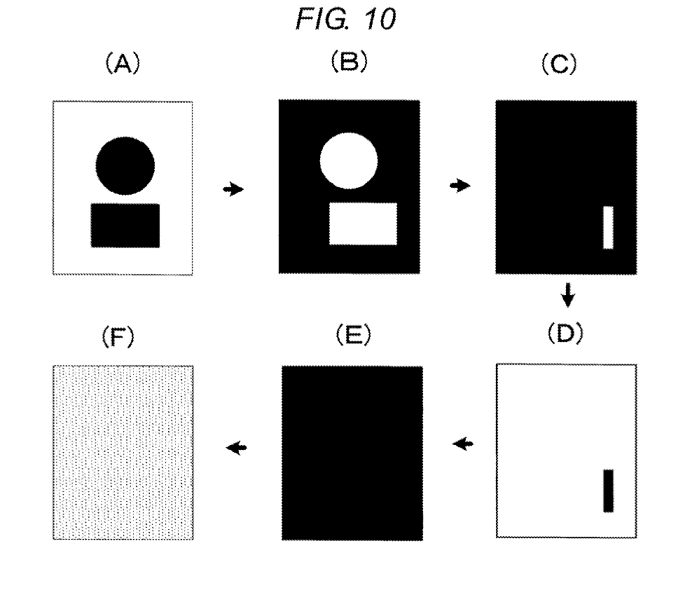

The control unit 21 determines that the decolorization process setting and the security setting are input in the operation input unit 22 insteps S301, S302 (YES), and S303 (YES). Thereafter, similar to the processing operation according to the first embodiment, the control unit 21 operates the image forming unit 15, transfers the decolorable toner to the sheet, on which an image as shown in FIG. 10(A) is printed, in the first print target area as in FIG. 10(B), and forms a sheet to which the decolorable toner is transferred as shown in FIG. 10(C) in steps S305 to S308. Meanwhile, since the operation of transferring the decolorable toner by the image forming unit 15 according to the third embodiment in steps S305 to S308 is the same as the operation of transferring the decolorable toner by the image forming unit 15 according to the first embodiment in steps S105 to S108, the description thereof will not be repeated.

The control unit 21 operates the second reverse transportation unit 18, and transports the sheet, to which the decolorable toner is transferred, from the image forming unit 15 to the image reading unit 14 in step S309. The control unit 21 operates the image reading unit 14, reads an image which is transferred to the transported sheet, and stores read image data in the storage unit 20. The control unit 21 analyzes the image data which is stored in the storage unit 20, determines a non-print area, in which the decolorable toner is not printed, of the sheet, sets the non-print area to a third print target area, operates the image forming unit 15, transfers the decolorable toner to the entire third print target area as shown in FIG. 10(D), and forms an image on the sheet such that the image becomes the state shown in FIG. 10(E) in steps S310 and S311.

The control unit 21 operates the transportation roller 121 and the heating and decolorizing unit 16, sets the heating temperature of the heating and decolorizing unit 16 to the decolorizing temperature, transports the sheet, to which the decolorable toner is transferred, to the heating and decolorizing unit 16, heats the sheet at the decolorizing temperature, and decolorizes the image which is transferred to the sheet as shown in FIG. 10(F) in step S312. In addition, the control unit 21 operates the paper ejection roller 122, discharges the sheet, on which the decolorization process is performed, to the reuse paper tray 13, and ends the decolorization process in steps S313 and S314.

In the decolorizing device 1 according to the third embodiment, even when the decolorable toner is transferred while the first print target area which is set by the control unit 21 is deviated from the non-print area of the sheet which is acquired before the decolorization process is performed (as shown in FIG. 10(C)), security can be improved. That is, the state of the image which is transferred to the sheet is read by the image reading unit 14 after the operation of transferring the decolorable toner is performed on the first print target area, and the non-print area to which the decolorable toner is not transferred is used as the third print target area. Thus it is possible to prevent an area in which the decolorable toner is not printed from being generated in the surface, on which the decolorization process is performed, of the sheet acquired after the decolorization process is performed.

The decolorizing device 1 according to the third embodiment is different from the decolorizing device 1 according to the second embodiment. The image reading unit 14 reads the state of the image, which is transferred to the sheet acquired after the decolorable toner is transferred to the first print target area by the image forming unit 15, the decolorable toner is transferred to only the non-print area which is determined based on the result of reading the state of the image, and thus it is possible to form a sheet in which a single-layered decolorable toner is uniformly transferred to the entire print surface of the sheet. That is, in the sheet on which the decolorization process is performed by the decolorizing device 1 according to the third embodiment, it is possible to prevent a difference between an area to which the single-layered decolorable toner is fixed and an area to which the two-layered decolorable toner is fixed from being generated in the sheet. As described above, since it is possible for the decolorizing device 1 according to the third embodiment to fix the decolorable toner to the sheet, acquired after the decolorization process is performed, to uniform thickness, it is possible to securely prevent the image on the sheet, acquired before the decolorization process is performed, from being read based on the thickness of the decolorable toner that is fixed to the sheet acquired, after the decolorization process is performed. Therefore, it is possible for the decolorizing device 1 according to the third embodiment to increase a security level related to the sheet which is the decolorizing target, compared to the decolorizing devices 1 according to the first embodiment and the second embodiment.

In the decolorizing devices 1 according to the first embodiment to the third embodiment, the area which is determined as the non-print area by the control unit 21 is described as the entire surface of the sheet on which the image is formed. However, the exemplary embodiments are not particularly limited thereto and a print target area which is set by the user may be determined as the non-print area. More specifically, after the image which is printed on the sheet is read by the image reading unit 14, the control unit 21 displays a selection input screen on the display unit 221 in order to select a security processing target from among areas (print target areas) of the image data, and prompts the user to perform input related to the print target area. If the control unit 21 determines that the print target area is selected and input by the user in the operation input unit 22, the control unit 21 analyzes image data in the print target area, determines a non-print area, and sets the non-print area to the first print target area. In addition, the control unit 21 operates the image forming unit 15, and transfers the decolorable toner to the entire first print target area. With regard to the later process, the same processes are performed as in the processing operations according to the first embodiment to the third embodiment, and thus the description thereof will not be repeated.

As described above, the first print target area to which the decolorable toner is transferred is set in a particular print target area which is set by the user, and thus it is possible to suppress the amount of the decolorable toner used, which accompanies the security setting process, to the minimum necessary.

In the above embodiments, although cases in which the decolorization processing method according to the exemplary embodiment is operated in the decolorizing device 1 has been described, the decolorization processing method according to the exemplary embodiment may be operated in the image forming device (not shown).

More specifically, when a print job is transmitted from an information terminal to an image forming device, the transmitted print job is stored in the storage unit 20, the control unit 21 operates the paper feeding unit 11, the transportation roller 121 and the image forming unit 15, and performs an image forming process on a sheet which is fed from the paper feeding unit 11 based on the stored print job. The control unit 21 operates the heating and decolorizing unit 16, sets the heating temperature of the heating and decolorizing unit 16 to a fixing temperature (in the embodiment, in the range of approximately 150° C. to 160° C.) and fixes the toner image which is transferred to the sheet by the image forming unit 15 to the sheet. Further, the control unit 21 operates the paper ejection roller 122, and discharges the sheet, to which image is fixed by the heating and decolorizing unit 16, to the reuse paper tray 13.

Meanwhile, with regard to the processing operation when the user inputs the decolorization process setting and the security setting in the operation input unit 22 of the image forming device, the same processing operations are performed as in the decolorizing device 1 according to the first embodiment to the third embodiment, and thus the description thereof will not be repeated.

In the embodiments, although description has been made such that the decolorization process setting and the security setting are input in the operation input unit 22, the exemplary embodiments are not particularly limited thereto. Inputs related to the setting may be received from an information terminal to the decolorizing device 1 or the image forming device.

In addition, the program which is described in the embodiments is recorded in a computer-readable recording medium, read by a computer, and is configured to include a function of executing a processing method using the image forming device or the decolorizing device 1 according to the exemplary embodiments in the computer. With regard to such a function, in the embodiments, a case has been described in which the function of implementing the exemplary embodiments is recorded in the image forming device or the decolorizing device 1 in advance. However, the exemplary embodiments are not limited thereto, and the same function may be downloaded from the communication unit 23 to a device or the same function which is stored in a recording medium may be installed in a device. Any type of a recording medium, such as a CD-ROM, which can store a program and which can be read by the image forming device or the decolorizing device 1 may be used as the recording medium. In addition, a function which can be acquired through installation or downloading in advance may be implemented in cooperation with an Operating System (OS) in the image forming device or the decolorizing device 1.

As described above, according to the technology disclosed in the disclosure, it is possible to prevent an image which is printed on a sheet acquired before a decolorization process is performed from being read from a sheet acquired after the decolorization process is performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A decolorization method comprising:
reading an image that is printed on a sheet surface with a decolorable toner which is decolorized when heated to a decolorizing temperature;
determining a non-print area of the sheet surface that has no decolorable toner based on the read image and setting the non-print area as a first print target area;
transferring decolorable toner to the first print target area; and
heating the sheet surface having decolorable toner transferred to the first print target area, at the decolorizing temperature by a heating unit.

2. The method according to claim 1, further comprising:
after heating the sheet surface by the heating unit, setting the entire sheet surface as a second print target area;
transferring decolorable toner to the second print target area; and
heating the sheet surface having decolorable toner transferred to the second print target area, at the decolorizing temperature by the heating unit.

3. The method according to claim 1, further comprising:
after decolorable toner is transferred to the first print target area and before the sheet is heated by the heating unit, reading a second image that is printed on the sheet surface;
determining a non-print area of sheet surface that has no decolorable toner based on the read image and setting the non-print area as a third print target area; and
transferring the decolorable toner to the third print target area, wherein
heating the sheet surface includes heating the sheet surface having decolorable toner transferred to the first print target area and to the third print target area, at the decolorizing temperature by the heating unit.

4. The method according to claim 1, further comprising:
accepting a user input regarding the first print target area, wherein
determining the non-print area of the sheet surface is based on the read image and on the user input.

5. The method according to claim 1, further comprising:
accepting a user input for selecting a security setting.

6. The method according to claim 1, further comprising:
receiving the sheet from an image forming apparatus.

7. The method according to claim 1, wherein the heating unit is configured to heat the sheet surface to a fixing temperature lower than the decolorizing temperature.

8. A decolorizing device comprising:
an image reading unit configured to read an image that is printed on a sheet surface;
an image forming unit configured to transfer a decolorable toner, which is decolorized heated to a decolorizing temperature, to a first print target area of the sheet surface;
a heating unit configured to heat the sheet surface having the decolorable toner transferred onto the first print target area by the image forming unit, to the decolorizing temperature; and
a control unit that determines a non-print area of the sheet surface that has no decolorable toner based on the image read by the image reading unit, sets the non-print area as the first print target area, and controls the image forming unit and the heating unit.

9. The decolorizing device according to claim 8, wherein:
the control unit is configured to set the entire sheet surface as a second print target area after the sheet surface is heated by the heating unit,
the image forming unit is configured to transfer decolorable toner to the second print target area, and
the heating unit is configured to heat the sheet surface having decolorable toner transferred to the second print target area, at the decolorizing temperature.

10. The decolorizing device according to claim 8, wherein:
the reading unit is configured to read a second image that is printed on the sheet surface after decolorable toner is transferred to the first print target area and before the sheet is heated by the heating unit,
the control unit is configured to determine a non-print area of sheet surface that has no decolorable toner based on the second image, and set the non-print area as a third print target area,
the image forming unit is configured to transfer the decolorable toner to the third print target area, and
the heating unit is configured to heat the sheet surface having decolorable toner transferred to the first print target area and to the third print target area, at the decolorizing temperature.

11. The decolorizing device according to claim 8, further comprising:
an input unit configured to accept a user input regarding the first print target area, wherein
the control unit determines the non-print area of the sheet surface based on the read image and on the user input.

12. The decolorizing device according to claim 8, further comprising:
an input unit configured to accept a user input for selecting a security setting.

13. The decolorizing device according to claim 8, wherein the sheet is received from an image forming apparatus.

14. The decolorizing device according to claim 8, wherein the heating unit is configured to heat the sheet surface to a fixing temperature lower than the decolorizing temperature.

15. A non-transitory computer readable medium containing software for use in a decolorization device, the software causing the decolorization device to perform the following functions:
reading an image that is printed on a sheet surface with a decolorable toner which is decolorized when heated to a decolorizing temperature;
determining a non-print area of the sheet surface that has no decolorable toner based on the read image and setting the non-print area as a first print target area;
transferring decolorable toner to the first print target area; and
heating the sheet surface having decolorable toner transferred to the first print target area, at the decolorizing temperature by a heating unit.

16. The non-transitory computer readable medium according to claim 15, wherein the software causes the decolorization device to perform the following further functions:
after heating the sheet surface by the heating unit, setting the entire sheet surface as a second print target area;
transferring decolorable toner to the second print target area; and
heating the sheet surface having decolorable toner transferred to the second print target area, at the decolorizing temperature by the heating unit.

17. The non-transitory computer readable medium according to claim 15, wherein the software causes the decolorization device to perform the following further functions:
after decolorable toner is transferred to the first print target area and before the sheet is heated by the heating unit, reading a second image that is printed on the sheet surface;
determining a non-print area of sheet surface that has no decolorable toner based on the read image and setting the non-print area as a third print target area; and
transferring the decolorable toner to the third print target area, wherein
heating the sheet surface includes heating the sheet surface having decolorable toner transferred to the first print target area and to the third print target area, at the decolorizing temperature by the heating unit.

18. The non-transitory computer readable medium according to claim 15, wherein the software causes the decolorization device to perform the following further function:
accepting a user input regarding the first print target area, wherein
determining the non-print area of the sheet surface is based on the read image and on the user input.

19. The non-transitory computer readable medium according to claim 15, wherein the software causes the decolorization device to perform the following further function:
accepting a user input for selecting a security setting.

20. The non-transitory computer readable medium according to claim 15, wherein the software causes the decolorization device to perform the following further function:
receiving the sheet from an image forming apparatus.
